(19) United States
(12) Patent Application Publication
(10) Pub. No.: US 2021/0176280 A1
(43) Pub. Date: Jun. 10, 2021

(54) GENERATION OF CODE EXECUTABLE TO IMPLEMENT A DATA REPLICATION POLICY BASED ON USER INPUT

(71) Applicant: salesforce.com, inc., San Francisco, CA (US)

(72) Inventor: Swaroop Jayanthi, Hyderabad (IN)

(21) Appl. No.: 16/747,342

(22) Filed: Jan. 20, 2020

Related U.S. Application Data
(60) Provisional application No. 62/945,616, filed on Dec. 9, 2019.

(51) Int. Cl. H04L 29/06; G06F 8/41; G06F 8/70; H04L 9/06; G06F 16/178

(52) U.S. Cl. CPC H04L 63/20; G06F 8/44; G06F 8/427; G06F 3/0482; H04L 9/0643; G06F 16/178; G06F 8/70

(57) ABSTRACT

Techniques are disclosed relating to generating code that is executable to implement a data replication policy. In various embodiments, a computer system provides, to a client device, code that is usable to generate a GUI that enables a user of the client device to define a data replication policy, via the GUI, to be implemented during a data replication operation. The computer system may then receive, from the client device, user input provide via the GUI that defines a first data replication policy, where the user input indicates a series of transformations to be performed, as part of the first data replication policy, on a first database object from a source database to replicate a transformed version of the first database object to a target database. Based on the user input, the computer system may generate code that is executable to implement the first data replication policy.

This application claims the benefit of U.S. Provisional Application No. 62/945,616, filed on Dec. 9, 2019, which is hereby incorporated by reference as if entirely set forth herein.

### BACKGROUND

### Technical Field

This disclosure relates generally to data privacy and data security, and more particularly to generating code executable to implement a data replication policy, according to various embodiments.

### Description of the Related Art

Maintaining data availability and consistency across databases in cloud-based applications presents a significant technical problem. For example, it is important for users to be compliant with the General Data Protection Regulation (GDPR) for data that is replicated across the cloud to different datacenters. As a non-limiting example, consider a database located in the United States that stores users' personal information, such as name, age, gender, address, SSN, etc. If this data needs to be replicated from its source database in the U.S. to a target database outside of the U.S. (e.g., to a target database located in an EU member state), it may be necessary to transform some portion(s) of the data to satisfy security concerns and comply with GDPR (or other) requirements.

### BRIEF DESCRIPTION OF THE DRAWINGS

FIG. 1 is a block diagram illustrating an example system for generating code, based on a user's actions via a GUI, which is executable to implement data replication policies, according to some embodiments.

FIG. 2 is a block diagram illustrating an example server system and policy designer module, according to some embodiments.

FIG. 3 is a block diagram illustrating an example system that may be used to replicate data from a source database at source system to a target database at a target system based on a data replication policy specified by a user, according to some embodiments.

FIG. 4 depicts example transformations that may be performed as part of a data replication policy, according to some embodiments.

FIGS. 5A-5B show a code snippet of example code that may be used to implement a data replication policy, according to some embodiments.

FIGS. 6 and 7 are flow diagrams illustrating an example methods for generating code executable to implement a data replication policy based on user input, according to some embodiments.

FIG. 8 is a block diagram illustrating an example computer system, according to some embodiments.

FIG. 9 is a block diagram illustrating an example multi-tenant computing system, according to some embodiments.

### DETAILED DESCRIPTION

The amount of data that is generated, for example through the use of web services, is growing exponentially. Maintaining customers' data availability and consistency across databases in cloud-based applications presents a significant technical problem. For example, it is important for users to be compliant with GDPR or other data-privacy regulations for data that is replicated across datacenters, as noted above. To enable replication of data from a source database to a target database, a data replication policy may be applied. As used herein, the term “data replication policy” refers to a set of rules that govern the replication of data from a source data store (e.g., a database at a first datacenter) to a target data store (e.g., a second database at a second datacenter). Existing data replication systems present various technical shortcomings. For example, while such systems may enable data replication between databases using a data replication policy, such systems require the policy to be coded using hand-written rules (provided, for example, in the Human-Optimized Config. Object Notation (HOCON) format). Stated differently, these prior systems require data replication policies to be designed and implemented manually, which presents various technical problems. For example, coding such a data replication policy is a time-consuming and error-prone process, requiring the user to have a significant understanding of the database objects involved and the particular coding syntax (e.g., the HOCON format). Consider, as one non-limiting example, an instance in which the user (e.g., a database administrator) manually codes a policy at the row/column level for an organization (e.g., a tenant of a multi-tenant system) but the code contains a syntactical or semantic error. In such a situation, the data replication operation will be interrupted, costing significant time and effort in resolving the error. If the policy has any syntactic or semantic errors, the data will not be replicated accurately, potentially violating GDPR or other data-privacy mandates.

In various embodiments, the disclosed systems and methods address these and other technical problems by allowing a user to define a data replication policy based on the user's interaction with a policy designer graphical user interface (GUI). Based on the user's input, the disclosed systems and methods are operable to generate code that is executable to implement the data replication policy (e.g., by performing various transformations to selected data objects) without requiring the user manually write the code. For example, in some embodiments, the disclosed techniques include a policy designer module that is operable to monitor and capture user-triggered actions, performed via a policy designer GUI, associated with various types of data objects (e.g., schemas, tables, columns, etc.) along with the transformations performed. The policy designer module may store information indicative of the user's input, such as information indicative of each user action, including, for a given data transformation, the data object involved and the order of the transformation in the sequence of the user's input. Based on this stored information, the policy designer module is operable to generate code (e.g., provided in HOCON format) executable to implement a data replication policy for use in a data replication operation. For example, in various embodiments, the policy designer module is operable to convert the information indicative of the user input into corresponding code statements (e.g., provided in any suitable format, such as HOCON). The policy designer module may generate one or more code statements for each of the transformations specified via the policy designer GUI such that the disclosed system generates code executable to implement a data replication policy specifying the transformations that the user wishes to make without requiring the user to go through the technically rigorous and error-prone process of manually coding the policy. In various embodiments, the disclosed techniques improve data security and compliance with privacy regulations during the data-replication process and improve the data-replication process as a whole.

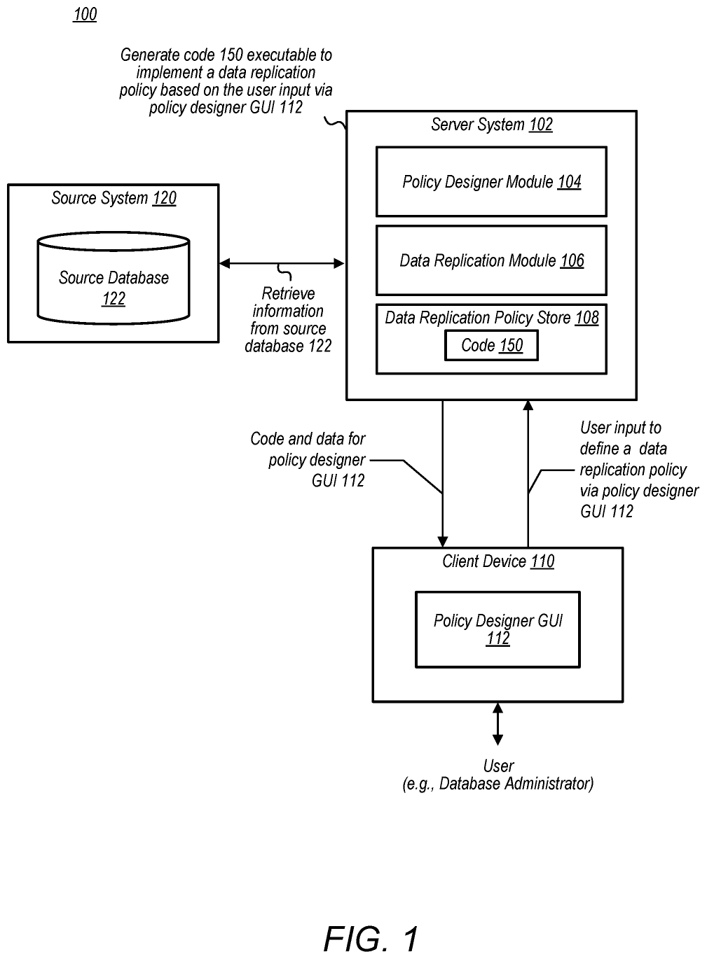

Referring now to FIG. 1, block diagram 100 depicts an example system for generating code executable to implement data replication policies based on user actions, according to some embodiments. In FIG. 1, diagram 100 includes server system 102, client device 110, and source system 120. Note that, although shown in direct communication, server system 102, client device 110, and source system 120 may be connected via one or more communication networks (not shown, for clarity).

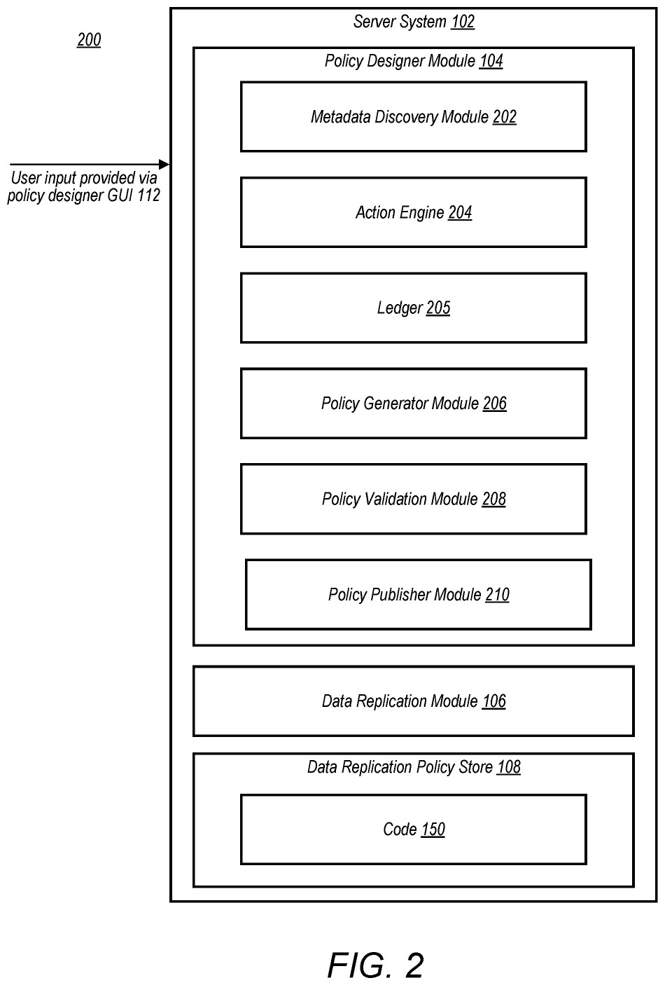

In FIG. 1, server system 102 includes policy designer module 104. In various embodiments, policy designer module 104 is operable to generate code executable to implement a data replication policy based on a user's input provided via a policy designer GUI 112, rather than requiring the user to write code for the policy manually. For example, in the depicted embodiment, a user of client device 110 may wish to design a data replication policy to replicate some or all of the data maintained in source database 122 at source system 120 to a target database (e.g., maintained at a different datacenter). In various embodiments, the server system 102 provides the user with a policy designer GUI 112 that enables a user of the client device 110 to define one or more data replication policies via the policy designer GUI 112. For example, the user may specify one or more database objects from source database 122 to be replicated to a target database. Further, as described in more detail below with reference to FIG. 2, the user may specify a series of one or more transformations to be performed, as part of a data replication policy, on the database objects during the data replication operation to replicate data from the source database 122 to one or more target databases. (In various embodiments, the disclosed systems and methods allow users to define a data replication policy via a GUI, such as policy designer GUI 112. In other embodiments, however, the disclosed systems and methods may provide any other suitable user interface that enables users to design a data replication using the user interface, rather than requiring the user to manually code the policy. As a non-limiting example, in some embodiments, the user of client device 110 is provided with a command-line interface (“CLI,” provided by the server system 102 as part of a web application, by a software application executing on the client device 110, etc.) that enables the user to define a data replication policy via the user's interaction with the CLI. In various embodiments, the CLI is a command prompt that allows the user to specify one or more desired transformations using a set of text-based commands, which may then be provided to the server system 102 for use in generating the code 150 executable to implement the data replication policy. In some instances, the interface through which the user of client device 110 provides input to define a data replication policy may be referred to as a “client layer,” which may include policy designer GUI 112 or a CLI, as two non-limiting examples.)

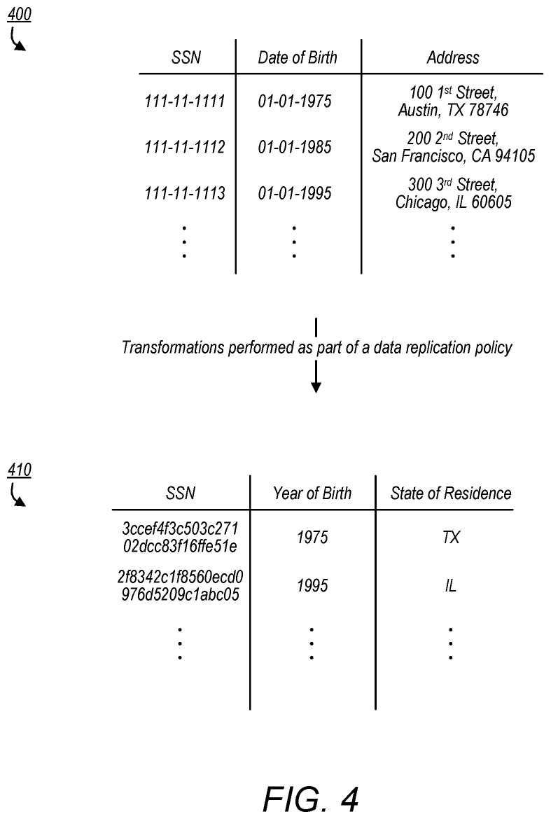

As used herein, the term “transformation” refers to a modification to one or more characteristics of a data object. One non-limiting example of a transformation is the modification of a name associated with a data object. For example, the user may select a column database object via the policy designer GUI 112 and specify a transformation that changes the name of the column database object when a transformed version of that database object is replicated to a target database. Another non-limiting example of a transformation is the modification of a value associated with a data object. For example, the user may select a table database object via the policy designer GUI 112 and specify transformation that modifies one or more of the values stored in the table database object. For instance, consider an embodiment in which a table database object stores users' personal information, such as a Social Security number (SSN) and residence address. In such an embodiment, user (e.g., the database administrator) may wish to mask the SSNs when the table database object is replicated to a target database (which may be located in another country, in some embodiments). For example, the user may wish to encrypt the SSNs using SHA1, MD4, or any other suitable encryption algorithm. In various embodiments, the user may provide input indicative of this desired transformation via the policy designer GUI 112 (e.g., using a series of drop-down menus or any other suitable input elements). In other embodiments, the user (e.g., the database administrator) may wish to not replicate the SSNs to the target database at all. In such an embodiment, the user may provide input indicating that the SSN portion (e.g., a column) of the table database object is not to be replicated as part of the data replication policy. Further, in some instances, the user may wish to modify the residence address information stored in the table database object. For example, the user may provide input specifying a transformation that modifies a street level address of the users to simply denote the state or country of residence of the users. Example transformations that a user may specify via the policy designer GUI 112 are described in more detail below with reference to FIG. 4.

Note that, in some embodiments, policy designer GUI 112 may be provided to the client device as a web application in which the server system 102 provides code and data usable to render the policy designer GUI 112 via a browser application executing on the client device 110. In other embodiments, policy designer GUI 112 may be provided as part of a software application executing on the client device 110. In such embodiments, server system 102 may provide the client device 110 with data indicative of one or more source databases (such as source database 122) to allow the user to define a data replication policy via the policy designer GUI 112.

In various embodiments, policy designer module 104 is operable to generate code 150 that is executable to implement the data replication policy specified by the user input via the policy designer GUI 112. For example, in some embodiments, the policy designer module 104 may store information indicative of the user input provided via the policy designer GUI 112. In various embodiments, policy designer module 104 may store metadata associated with the database objects on which one or more transformations are to be performed, details of the transformation to be performed, and an order in which the one or more transformations are to be performed. Stated differently, in various embodiments, policy designer module 104 stores information indicating the order and type of transformations applied for each of the database objects specified by the user via the policy designer GUI 112. Based on this information, the policy designer module 104 is operable to generate code 150 that is executable to implement the data replication policy specified by the user. For example, for each transformation specified by the user, the policy designer module 104 may generate one or more corresponding code statements that are executable to perform those transformations in the order specified by the user. In one non-limiting example, policy designer module 104 is operable to generate these code statements using a HOCON format. Once it has generated the code 150 executable to implement the data replication policy, policy designer module 104 may store this code in a data replication policy store 108. In various embodiments, data replication policy store 108 may be implemented using any of various suitable storage devices included in or accessible to (e.g., by direct connection or via one or more communication networks) server system 102. Note that, although shown as part of server system 102, data replication policy store 108 may be implemented using a storage device separate from and accessible to the server system 102 or the policy designer module 104.

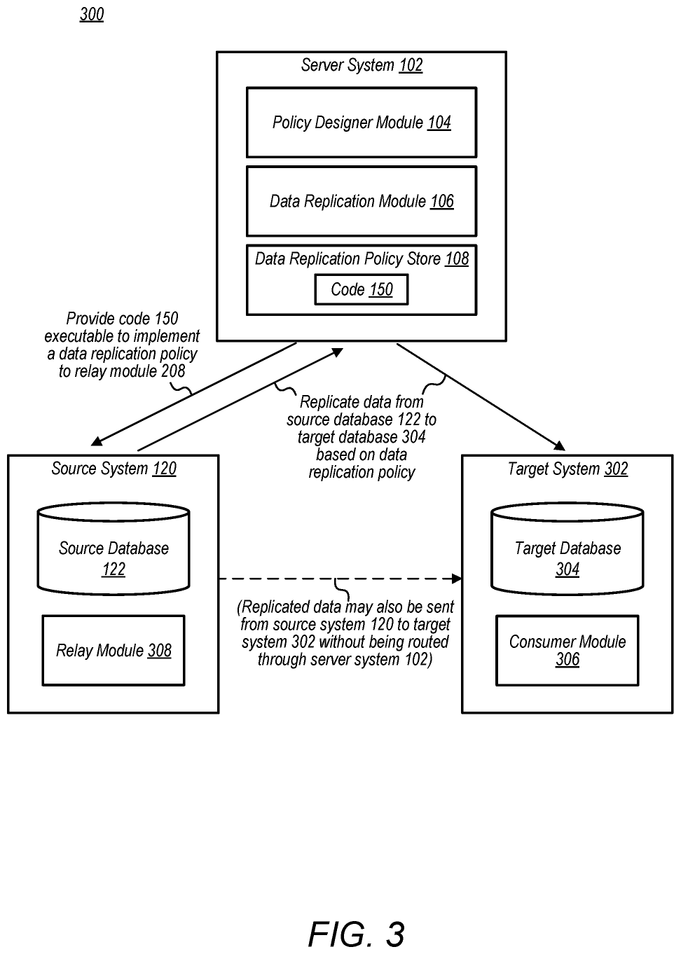

In FIG. 1, server system 102 further includes data replication module 106. In various embodiments, data replication module 106 is a software tool that enables data replication between a source database (e.g., at a first data center) and a target database (e.g., at a second, potentially remote data center) according to a data replication policy, as described in more detail below with reference to FIG. 3. In some embodiments, data replication module 106 enables data replication from one source to multiple targets or from multiple sources to multiple targets (e.g., in a “grid” topology). As one non-limiting example, data replication module 106 may be implemented using the Salesforce™ platform provided by Salesforce.com, Inc.

Note that, although policy designer module 104, data replication module 106, and data replication policy store 108 are shown on the same server system 102 in FIG. 1, this embodiment is provided merely as one non-limiting example. In other embodiments, one or more of policy designer module 104, data replication module 106, and data replication policy store 108 may be implemented using one or more computer systems.

Turning now to FIG. 2, a block diagram 200 depicts an example embodiment of server system 102 and policy designer module 104. As noted above, in various embodiments, policy designer module 104 is operable to generate code 150 executable to implement a data replication policy based on user input provided via a policy designer GUI 112. In various embodiments, this code 150 may be used during a data replication operation to replicate a transformed version of one or more data objects from a source database to a target database.

In FIG. 2, policy designer module 104 includes metadata discover module 202, which is operable to collect and manage metadata corresponding to the user input provided via the policy designer GUI 112. For example, as shown in FIG. 2, policy designer module 104 receives information indicative of the user input provided via the policy designer GUI 112. In various embodiments, metadata discovery module 202 may collect metadata corresponding to the source database 122 and the database objects (e.g., metadata indicative of object type, such as schema, table, column, etc.) in source database 122 based on the user input. In various embodiments, metadata discovery module 202 may store the metadata it collects in ledger 205. Ledger 205, in various embodiments, is used to store various items of information corresponding to the user input provided via policy designer GUI 112, including the database objects involved and the type and order of the transformations to be performed, along with any of various other items of information for use by the policy designer module 104 in generating the code 150 executable to implement the data replication policy. In various embodiments, ledger 205 may be implemented using any of various suitable data types (e.g., lists, sets, queues, stacks, etc.) or file types (e.g., text files, CSV files, JSON files, etc.). In some embodiments, metadata discovery module 202 may create a new ledger 205 for each data replication policy specified by the user via the policy designer GUI 112. The creation of a new ledger 205 may be triggered, for example, by the user selecting a database object (or some other input element) from the source database 122 via the policy designer GUI 112.

Policy designer module 104 further includes action engine 204. In various embodiments, action engine 204 is operable to capture the user input (e.g., performed by the user via the policy designer GUI 112) indicative of the one or more transformations to be performed as part of a data replication policy and store that information (e.g., in the ledger 205). For example, in some embodiments, the user may specify a series of one or more transformation to be made to a first database object stored in the source database 122 as part of a data replication policy. In various embodiments, the action engine 204 is operable to store information indicative of the series of one or more transformations (such as the type of transformations being made, steps involved in the transformations, etc.) and the order in which the transformations are to be performed. Stated differently, in various embodiments, the action engine 204 may store in ledger 205 an ordered list of the transformations to be applied to a database object. Ledger 205 may be stored in a storage device included in (or accessible to) the server system 102.

In FIG. 2, policy designer module 104 further includes policy generator module 206, which, in various embodiments, is operable to generate code 150 executable to implement a data replication policy based on the user input provided via the policy designer GUI 112. For example, in some embodiments, the policy generator module 206 is operable to read the information indicative of the user input from the ledger 205 and, for each of the transformations specified in the ledger 205, generate one or more code statements that are executable to perform the corresponding transformation. As noted above, in some embodiments, the code 150 executable to implement the data replication policy may be provided in a HOCON format. Note, however, that this embodiment is provided merely as a non-limiting example and, in other embodiments, any other suitable format may be used. Provided below is pseudo-code illustrating one non-limiting example of a function that policy generator module 206 may use to generate the code 150 executable to implement a data replication policy:

function generatePolicy(ledger):
policy = “io.griddable {“

for act in actions:

If act is ‘Schema’ && act == ‘synchronized’::

ledger[i].schema.name = schema.name
ledger[i].type= “SCHEMA”
ledger[i].action=act.transform.action
ledger[i].action.value=act.transform.value
ledger[i].synchronize= act.synchronize.value
ledger[i].order = act.order
ledger[i].specificity= act.specificity

If act is ‘table’ && act == ‘synchronized’::

ledger[i].table.name = table.name
ledger[i].type= “TABLE”
ledger[i].action=transform.action
ledger[i].action.value=”table change”

If act is ‘column’ && act == ‘synchronized’::

ledger[i].column.name = table.name
ledger[i].type= “COLUMN”
ledger[i].action= transform.action
ledger[i].action.value=”table change”

for rule in ledger:

if rule is excluded:

policy += “{ −”+ rule.schema.name + “}”

else if rule is not excluded:

policy +=″+rows″: [[
policy += “{ +”+ rule.table.name + “”

....

policy += “}”
return policy

Note, however, that this example function is provided merely as one non-limiting embodiment. In other embodiments, other suitable functions (or variations of the function provided above) may be used to generate the code 150 executable to implement the data replication policy.

In FIG. 2, policy designer module 104 further includes policy validation module 208. In various embodiments, policy validation module 208 is operable to validate the code 150 for both syntactic and semantic errors that may otherwise interfere with or impair code 150 from properly implemented the data replication policy. For example, if a data replication policy is not well-optimized, the performance of the data replication operations may be degraded. In various embodiments, policy validation module 208 is operable to validate the syntax of the code 150 based on the programming language or format in which the code 150 is provided. For example, if the code 150 is generated in HOCON format, the policy validation module 208, in various embodiments, is operable to verify that the one or more statements included in code 150 comply with the syntactical requirements of the HOCON format. Further, in various embodiments, the policy validation module 208 is operable to validate the semantics of the transformations specified by the code 150 to ensure that the data replication policy's structure is intact.

Policy designer module 104 further includes policy publisher module 210, which, in various embodiments, is operable to publish the code 150 to a requesting system. For example, once the code 150 has been successfully been validated by the policy validation module 208, the policy publisher module 210 is operable to read the code 150 from the data replication policy store 108 and send (that is “publish”) the code 150 to a requesting system for use in a data replication operation, as described in more detail below with reference to FIG. 3.

Referring now to FIG. 3, block diagram 300 depicts an example system that may be used to replicate data from a source database 122 at source system 120 to a target database 304 at a target system 302 according to a data replication policy specified by a user. In various embodiments, data may be replicated from source database 122 to target database 304 using code 150 that was generated, by policy designer module 104, based on user input provided via policy designer GUI 112. Note that, in some embodiments, source system 120 and target system 302 may be remotely located. For example, in some embodiments, source system 120 and target system 302 may be located in different states, countries, or even on different continents, such that different data privacy regulations apply in the locations in which the source system 120 and the target system 302 are respectively located.

In the depicted embodiment, source system 120 includes relay module 308. In various embodiments, relay module 308 is operable to execute the code 150 to perform the transformations specified in the data replication policy (that is, relay module 308 is operable to execute the code 150 to implement the data replication policy) on the data from source database 122 that is to be replicated. For example, in various embodiments, once a data replication operation is initiated, relay module 308 may retrieve code 150 from the server system 102. In some embodiments, relay module 308 may send a request to the policy designer module 104 identifying a particular data replication policy and, in response, policy publisher module 210 may retrieve and send the code 150 that is executable to implement the particular data replication policy to the relay module 308. (Note, however, that in some embodiments, the code 150 may be stored on or otherwise available to the source system 120 prior to initiation of the data replication operation such that the code 150 does not need to be requested from the server system 102.) Once it has access to the code 150, relay module 308 may execute the code 150 on the specified database objects from source database 122 to generate the transformed versions of these database objects. Relay module 308 may transfer the transformed database objects from the source system 120 to the target system 302. In the depicted embodiment, relay module 308 sends the transformed data via a databus service (e.g., using the Salesforce™ platform) using the data replication module 106. As indicated in FIG. 3, however, relay module 308 may also send the data to the target system 302 without using a databus service or routing it through server system 102, in at least some embodiments.

In the depicted embodiment, target system 302 includes target database 304 (the database to which the data is replicated) and consumer module 306. In various embodiments, consumer module 306 is operable to receive the transformed version of the data from the relay module 308 and to store the data in the target database 304. Note that, in some embodiments, transformations may be performed on the data to be replicated by relay module 308, by consumer module 306, or by both. For example, in some embodiments, once the consumer module 306 receives the transformed version of the data from the relay module 308, consumer module 306 may also perform one or more transformations on the data before it is stored in the target database 304. For example, as noted above, source system 120 and target system 302 may be located in different countries and, as such, data stored at the respective systems may be subject to different data-privacy regulations. To ensure compliance with applicable data-privacy regulations, target system 302 may separately apply a data replication policy to the data it receives prior to storing it in target database 304, in at least some embodiments.

In FIG. 3, relay module 308 is shown sending data to only one target system 302. Note, however, that this embodiment is provided merely as one non-limiting example. In other embodiments, relay module 308 may send data to various target systems located in various countries. In such embodiments, some or all of the target systems may apply additional data replication policies to the data received before it is stored on the respective systems. In various embodiments, the code used to perform any or all of these transformations may be generated by policy designer module 104 based on user input provided via a policy designer GUI 112, as described above with reference to FIGS. 1 and 2. In other embodiments, relay module 308 may not perform any transformations on the data from source database 122 and, instead, consumer module 306 may retrieve code 150 from server system 102 and execute the code 150 to implement the data replication policy generated based on the users input via the policy designer GUI 112.

Note that, although the policy designer module 104 is shown executing on a single server system 102 that is remote from source system 120 and target system 302, this embodiment is provided merely as one non-limiting example. In other embodiments, policy designer module 104 may be implemented as a microservice that may be executed by various computing systems within a public or private cloud, which may include the source system 120, the target system 302, or server system 102. For example, in some embodiments, each of source system 120, target system 302, and server system 102 may be implemented in one or more datacenter environments. For example, in some embodiments, each of server system 102, source system 120, and target system 302 may be implemented at separate datacenters. In other embodiments, however, one or more of server system 102, source system 120, and target system 302 may be implemented at the same datacenter.

FIG. 4 depicts example transformations that may be performed as part of a data replication policy, according to some embodiments. More specifically, FIG. 4 depicts various transformations performed on one or more database objects, for example by relay module 308 as it executes code 150 for a data replication policy that was generated based on user input provided via a policy designer GUI 112.

FIG. 4 depicts table 400, which includes a “SSN” column, a “Date of Birth” column, and an “Address” column. Table 400 includes three data records that include data for each of these fields. In various embodiments, table 400 may be implemented using one or more database objects (e.g., a table object, one or more column objects, a schema object, etc.) and stored in source database 122 at a source system 120. As described above, in various embodiments, a user (e.g., a database administrator) may design a data replication policy, via the policy designer GUI 112, that includes various transformations to be performed on the one or more database objects shown in table 400 when these database objects are replicated to a target database 304 at a target system 302.

FIG. 4 further depicts table 410, which shows a transformed version of the one or more database objects of table 400. In this depicted embodiment, three types of transformations have been performed on the database objects from table 400. First, names associated with the “Date of Birth” column object and the “Address” object have been changed to “Year of Birth” and “State of Residence,” respectively. Second, transformations have been performed to modify the values associated with the data stored in each of the three fields shown. For example, the SSNs included in table 400 have been replaced in table 410 with hash values corresponding to the SSNs. In the depicted embodiment, the MD4 hash function is used to generate the hash values shown in table 410, though any suitable function may be used, as desired. Further, data values in the “Date of Birth” column of table 400 have been modified to specify only the year in the “Year of Birth” column of table 410. Similarly, data values in the “Address” column of table 400 have been modified to specify only the state in the “State of Residence” column of table 410. Third, transformations have been performed so as to not replicate at least one record from table 400 to the table 410. For example, in the depicted embodiment, the second data record from table 400 has not been replicated, per the data replication policy, in table 410. In various embodiments, the user(s) designing the data replication policy may specify one or more transformations that opt to not replicate data meeting certain criteria. As a non-limiting example, in some embodiments, residents of some states, such as California, may be subject to additional data privacy protections. As such, the user designing the data replication policy may opt not to replicate some or all of the data (e.g., personal data) for users that are residents of such a state so as to ensure compliance with the applicable data privacy regulations.

Note that the transformations depicted in FIG. 4 are provided merely as non-limiting examples and, in other embodiments, a user may specify any suitable combination of transformations as part of a data replication policy. Further note that, in various embodiments, a data replication policy may be applied, and one or more transformations performed, prior to sending the database objects from the source system 120 to the target system 302 (e.g., by relay module 308 of FIG. 3), after being received at the target system 302 (e.g., by the consumer module 306), or both.

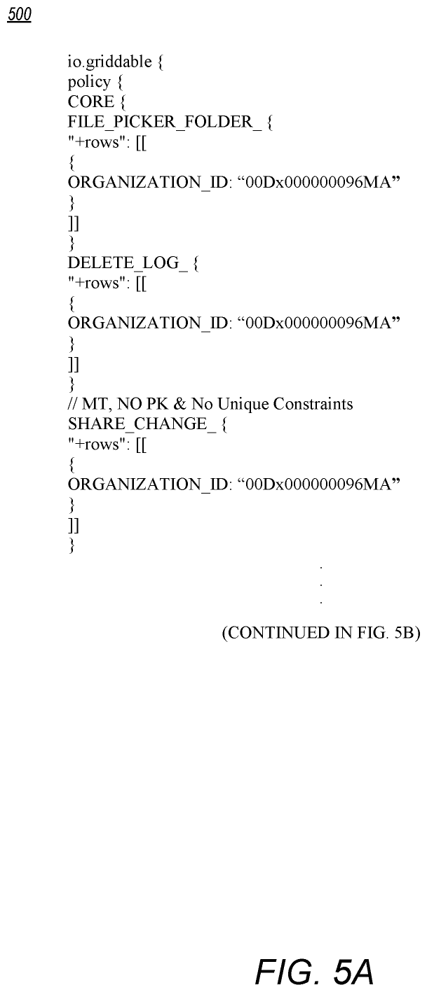

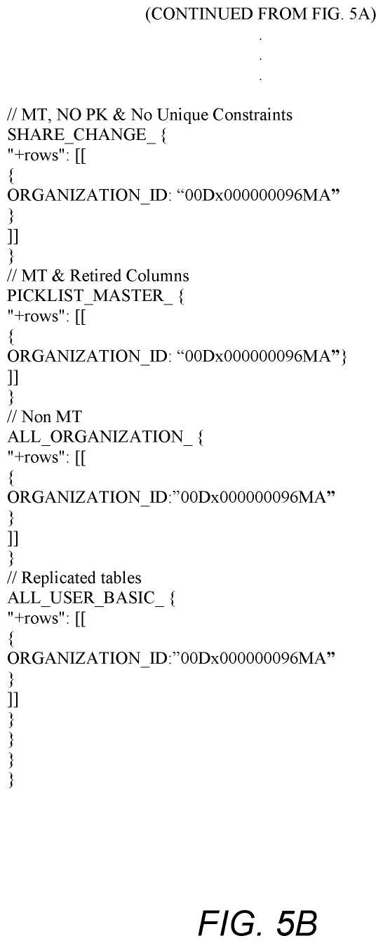

FIGS. 5A-5B show an example code snippet 500 that may be used to implement a data replication policy, according to some embodiments. For example, in some embodiments, code snippet 500 may be included in code 150 generated by policy designer module 104 based on user input provided, by a user, via policy designer GUI 112. In the depicted embodiment, code snippet 500 is provided in HOCON format. Note, however, that this embodiment is provided merely as one non-limiting embodiment and, in other embodiments, code 150 may be specified using any suitable language or format. As shown in FIGS. 5A-5B, code snippet 500 includes code statements that are executable to perform a series of transformations on one or more database objects in an order specified by the user (via the policy designer GUI 112). Note, however, that the particular code statements shown in code snippet 500 are provided merely as one non-limiting example and, in various embodiments, code 150 includes any suitable code statements executable to implement a data replication policy specified by a user (e.g., based on the user's actions) via the policy designer GUI 112.

### Example Methods

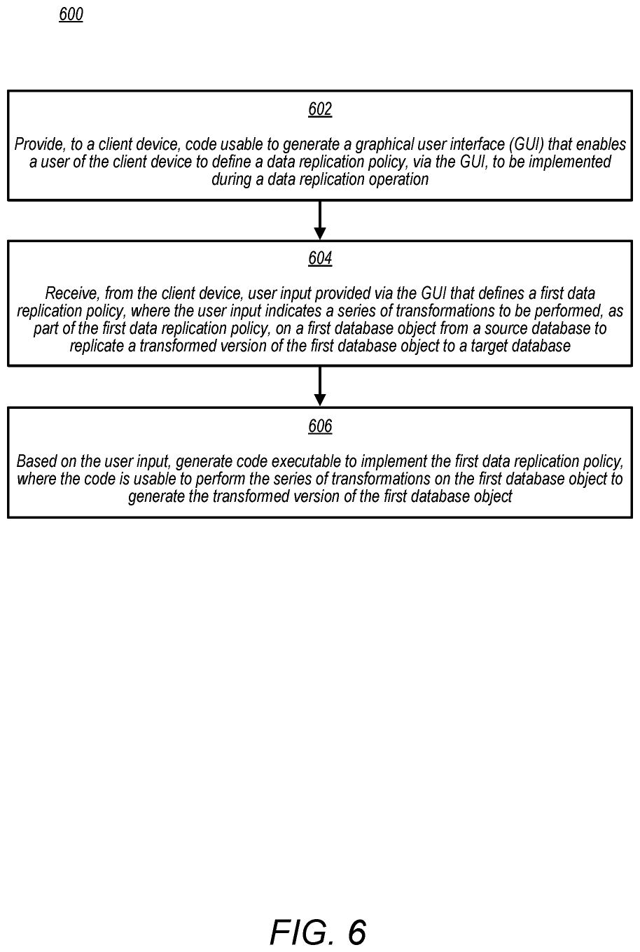

Referring now to FIG. 6, a flow diagram illustrating an example method 600 for generating code executable to implement a data replication policy based on user input is depicted, according to some embodiments. In various embodiments, method 600 may be performed by policy designer module 104 of FIG. 1 to generate code 150 that is executable to implement a data replication policy based on user input provided via the policy designer GUI 112. For example, server system 102 may include (or have access to) a non-transitory, computer-readable medium having program instructions stored thereon that are executable by the server system 102 to cause the operations described with reference to FIG. 6. In FIG. 6, method 600 includes elements 602-606. Although these elements are shown in a particular order for ease of understanding, other orders may be used. In various embodiments, some of the method elements may be performed concurrently, in a different order than shown, or may be omitted. Additional method elements may also be performed as desired.

At 602, in the illustrated embodiment, a computer system provides, to a client device, code that is usable to generate a GUI that enables a user of the client device define a data replication policy, via the GUI, to be implemented during a data replication operation. For example, policy designer module 104 may generate code (e.g., specified using HTML, JavaScript, or any other suitable programming or markup language) that is usable by client device 110 (e.g., by a browser application executing on the client device 110) to provide the policy designer GUI 112 to a user of client device 110. As described above, in various embodiments, policy designer GUI 112 may be used to define a data replication policy based on the user's actions, rather than requiring the user manually write code for the data replication policy.

At 604, in the illustrated embodiment, the computer system receives, from the client device, user input provided via the GUI that defines a first data replication policy. In various embodiments, the user input indicates a series of transformations to be performed, as part of the first data replication policy, on first database object from a source database to replicate a transformed version of the first database object to a target database. For example, the user may provide input via the policy designer GUI 112 to define a data replication policy, including one or more transformations to be made to one or more database objects, to replicate data from the source database 122 to a target database 304. In various embodiments, receiving the user input includes detecting user actions performed via the GUI at the client device. Further note that, in various embodiments, the computer system stores information indicative of the user input, such as metadata associated with the first database object and an order in which the series of transformations are to be performed on the first database object.

At 606, in the illustrated embodiment, the computer system generates, based on the user input, code that is executable to implement the first data replication policy, where the code is usable to perform the series of transformations on the first database object to generate the transformed version of the first database object. For example, as described above with reference to FIG. 2, policy generator module 206 is operable to generate code 150 that is executable to implement the first data replication policy based on the users input via the policy designer GUI 112. In various embodiments, the computer system is operable to generate the code 150 based on the user's input via the policy designer GUI 112 and without further user action by the user (e.g., without requiring the user to manually write the code 150). Further, in various embodiments, generating the code 150 includes generating one or more code statements that are executable to perform the series of transformations, on the first database object, in the order specified by the user input. As a non-limiting example, in some embodiments the code 150 is specified using HOCON format.

In some embodiments, method 600 further includes receiving, by the computer system, second user input associated with a second database object in the source database, where the second user input corresponds to a second series of transformations to be performed, as part of the first data replication policy, to replicate a transformed version of the second database object. In some such embodiments, generating the code 150 executable to implement the first data replication policy includes generating one or more code statements that are executable to perform the second series of transformations, on the second database object, in an order specified by the second user input. Note that, in some embodiments, the second database object may be of a different object-type than the first database object, and that the second series of transformations may be different from the series of transformations to be performed on the first database object.

Note that, in some embodiments, subsequent to generating the code executable to implement the first data replication policy, the computer system validates the code to identify any syntactical or semantical errors. In some such embodiments, in response to a determination that the code does not include any syntactical or semantical errors (or the code does not include significant errors such that the code is deemed suitable for use), the computer system sends the code to a source datacenter (e.g., source system 120) at which the source database (e.g., source database 122) is maintained. Further note that, in some embodiments, the source database is a multi-tenant database that is configured to store data for a plurality of tenants, where the data replication policy is usable to replicate database objects, from the source database, that are associated with a first one of the plurality of tenants.

In some embodiments, method 600 further includes the computer system receiving the transformed version of the first database object (e.g., from the source system 120) and sending the transformed version of the first database object to a target datacenter at which the target database is maintained. As noted above, in some embodiments, the source datacenter (at which the source database is maintained) and the target datacenter (at which the target database is maintained) are located in different countries and, potentially, on different continents. In some embodiments, method 600 further includes the computer system receiving second user input provided via the GUI that defines a second data replication policy, where the second user input indicates a second series of transformations to be performed, on one or more database objects, prior to storage in the target database at the target datacenter. For example, as described above with reference to FIG. 3, target system 302 may be subject to different or additional data-privacy regulations (relative to the source system 120) and, to ensure compliance with these regulations, the target system 302 may implement an additional data replication policy to the data it receives prior to storing it in the target database 304. In some embodiments, method 600 further includes generating, based on this second user input, second code that is executable to implement the second data replication policy, where the second code is usable to perform the second series of transformations on the transformed version of the first database object, and send the second code to at least one computer system located at the target datacenter.

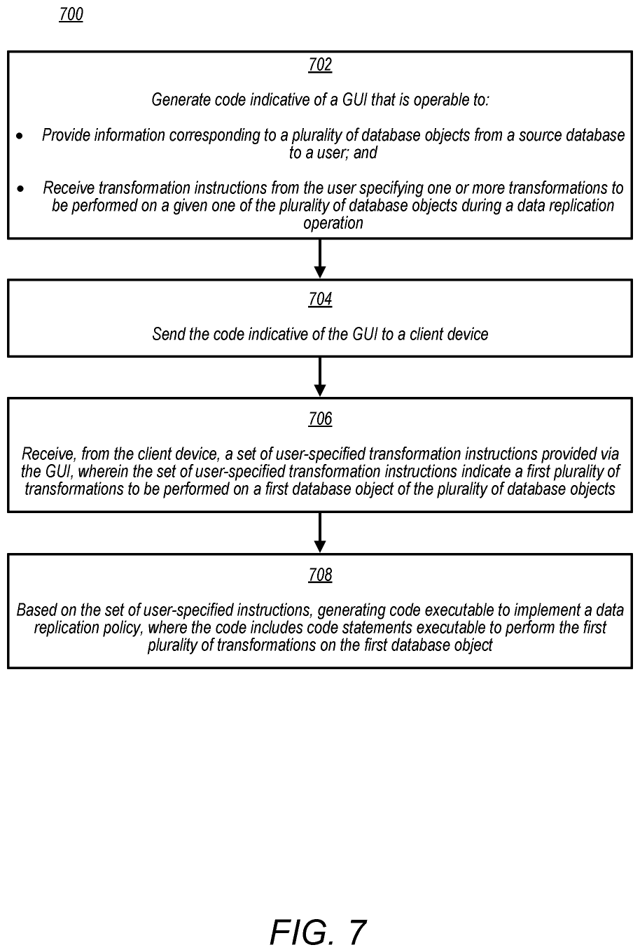

Referring now to FIG. 7, a flow diagram illustrating an additional example method 700 for generating code executable to implement a data replication policy based on user input is depicted, according to some embodiments. In various embodiments, method 700 may be performed by policy designer module 104 of FIG. 1 to generate code 150 that is executable to implement a data replication policy based on user input provided via the policy designer GUI 112. For example, server system 102 may include (or have access to) a non-transitory, computer-readable medium having program instructions stored thereon that are executable by the server system 102 to cause the operations described with reference to FIG. 7. In FIG. 7, method 700 includes elements 702-708. Although these elements are shown in a particular order for ease of understanding, other orders may be used. In various embodiments, some of the method elements may be performed concurrently, in a different order than shown, or may be omitted. Additional method elements may also be performed as desired.

At 702, in the illustrated embodiment, a server system generates code indicative of a GUI that is operable to: provide information corresponding to a plurality of database objects from a source database to a user, and receive transformation instructions from the user specifying one or more transformations to be performed on a given one of the plurality of database objects during a data replication operation. For example, in various embodiments, policy designer module 104 is operable to generate code for the policy designer GUI 112. At 704, in the illustrated embodiment, the server system sends the code indicative of the GUI to a client device, such as client device 110.

At 706, in the illustrated embodiment, the server system receives, from the client device, a set of user-specified transformation instructions provided via the GUI, where the set of user-specified transformation instructions indicate a first plurality of transformations to be performed on a first database object of the plurality of database objects. In some embodiments, the first plurality of transformations includes at least one of modifying a name associated with the first database object, and modifying a value associated with the first database object (as two non-limiting examples). In some embodiments, modifying the value associated with the first database object includes encrypting the value using a first encryption algorithm, such as the SHA1 algorithm.

At 708, in the illustrated embodiment, the server system generates, based on the set of user-specified instructions, code executable to implement a data replication policy, where the code includes code statements executable to perform the first plurality of transformations on the first database object. In some embodiments, method 700 further includes the server system sending the code executable to implement the data replication policy to a computer system at the first datacenter, receiving, from the computer system at the first datacenter, a transformed version of the first database object, and sending the transformed version of the first database object to a second computer system at a second datacenter for storage in a second database, as described in more detail above with reference to FIG. 3.

### Example Computer System

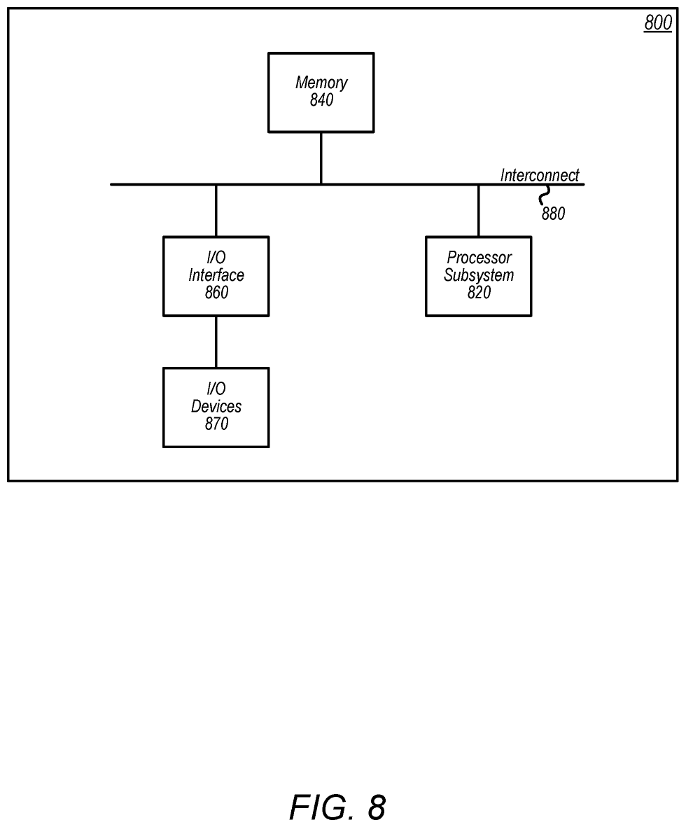

Referring now to FIG. 8, a block diagram of an example computer system 800 is depicted, which may implement one or more computer systems, such as server system 102 of FIG. 1, according to various embodiments. Computer system 800 includes a processor subsystem 820 that is coupled to a system memory 840 and I/O interfaces(s) 860 via an interconnect 880 (e.g., a system bus). I/O interface(s) 860 is coupled to one or more I/O devices 870. Computer system 800 may be any of various types of devices, including, but not limited to, a server computer system, personal computer system, desktop computer, laptop or notebook computer, mainframe computer system, server computer system operating in a datacenter facility, tablet computer, handheld computer, workstation, network computer, etc. Although a single computer system 800 is shown in FIG. 8 for convenience, computer system 800 may also be implemented as two or more computer systems operating together.

Processor subsystem 820 may include one or more processors or processing units. In various embodiments of computer system 800, multiple instances of processor subsystem 820 may be coupled to interconnect 880. In various embodiments, processor subsystem 820 (or each processor unit within 820) may contain a cache or other form of on-board memory.

System memory 840 is usable to store program instructions executable by processor subsystem 820 to cause system 800 perform various operations described herein. System memory 840 may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 800 is not limited to primary storage such as system memory 840. Rather, computer system 800 may also include other forms of storage such as cache memory in processor subsystem 820 and secondary storage on I/O devices 870 (e.g., a hard drive, storage array, etc.). In some embodiments, these other forms of storage may also store program instructions executable by processor subsystem 820.

I/O interfaces 860 may be any of various types of interfaces configured to couple to and communicate with other devices, according to various embodiments. In one embodiment, I/O interface 860 is a bridge chip (e.g., Southbridge) from a front-side to one or more back-side buses. I/O interfaces 860 may be coupled to one or more I/O devices 870 via one or more corresponding buses or other interfaces. Examples of I/O devices 870 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 870 includes a network interface device (e.g., configured to communicate over WiFi, Bluetooth, Ethernet, etc.), and computer system 800 is coupled to a network via the network interface device.

### Example Multi-Tenant Computer System

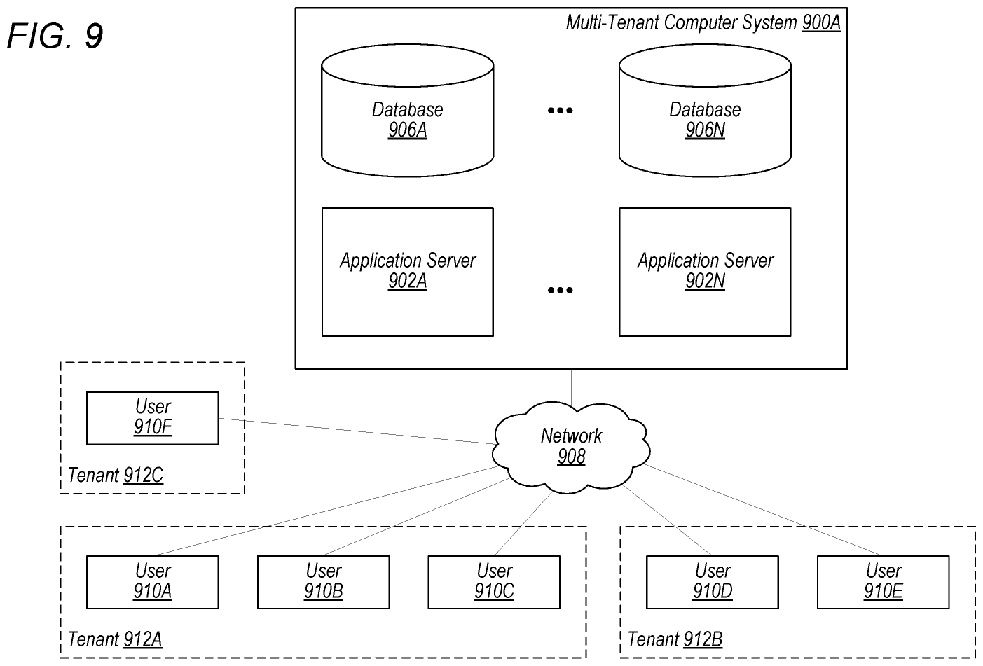

Turning now to FIG. 9, a block diagram illustrating an example multi-tenant computer system (MTCS) 900A is shown, according to some embodiments. In the embodiment shown in FIG. 9, MTCS 900A includes application servers 902 and databases 906. In various embodiments, databases 906 may are multi-tenant databases configured to store data for a plurality of tenants associated with MTCS 900A.

In various embodiments, MTCS 900A may be configured to provide computing resources to users 910 associated with various tenants 912 of MTCS 900A. For example, MTCS 900A may host software applications (e.g., using application servers 902) and store data (e.g., using multi-tenant databases 906) for various tenants 912 such that users 910 associated with the tenants 912 may access the software applications and data via network 908. Network 908 may be any suitable network implemented as a LAN (local area network), WAN (wide area network), wireless network, point-to-point network, star network, token ring network, hub network, or any other appropriate configuration or combination thereof. In various embodiments, tenant data (e.g., stored in databases 906) may be maintained such that the data of one tenant (e.g., tenant 912A) is kept separate from the data of another tenant (e.g., tenant 912C) such that the separate tenants do not have access to the other's data, unless such data is expressly shared.

In some instances, various embodiments of the present disclosure may be implemented in the context of one or more multi-tenant computer systems, such as MTCS 900A of FIG. 9. For example, in some embodiments, server system 102 of FIG. 1 may be included as part of MTCS 900A, or one or more of the modules described above with reference to server system 102 (e.g., policy designer module 104, data replication module 106, or data replication policy store 108) may be executed on one or more application servers 902 at MTCS 900A. Note that, although only a single MTCS 900A is shown in FIG. 9, this embodiment is provided merely as one example. In other embodiments, the disclosed techniques may be implemented to facilitate data replication operations from a source database 122 stored at one MTCS 900A (e.g., in one or more of the multi-tenant databases 906) in a first location (e.g., within the United States) to a target database 304 stored at a MTCS 900B in a second, different geographic location (e.g., in France). However, note that embodiments in which the disclosed systems and methods are implemented in the context of a multi-tenant environment are provided merely as non-limiting examples. Various embodiments of the disclosed techniques may also be implemented in a non-multi-tenant environment, as desired.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for” [performing a function] construct.

In this disclosure, various “modules” operable to perform designated functions are shown in the figures and described in detail above (e.g., policy designer module 104, data replication module 106, etc.). As used herein, the term “module” refers to circuitry configured to perform specified operations or to physical, non-transitory computer-readable media that stores information (e.g., program instructions) that instructs other circuitry (e.g., a processor) to perform specified operations. Such circuitry may be implemented in multiple ways, including as a hardware circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
providing, by a computer system to a client device, code usable to generate a graphical user interface (GUI) that enables a user of the client device to define a data replication policy, via the GUI, to be implemented during a data replication operation;
receiving, by the computer system from the client device, user input provided via the GUI that defines a first data replication policy, wherein the user input indicates a series of transformations to be performed, as part of the first data replication policy, on a first database object from a source database to replicate a transformed version of the first database object to a target database; and
based on the user input, generating, by the computer system, code executable to implement the first data replication policy, wherein the code is usable to perform the series of transformations on the first database object to generate the transformed version of the first database object.

2. The method of claim 1, further comprising:
storing, by the computer system, information indicative of the user input, wherein the information indicates:
metadata associated with the first database object; and
an order in which the series of transformations are to be performed; and
wherein the generating the code executable to implement the first data replication policy includes:
generating one or more code statements that are executable to perform the series of transformations, on the first database object, in the order specified by the user input.

3. The method of claim 1, wherein the code executable to implement the first data replication policy is specified using a Human-Optimized Config. Object Notation (HOCON) format.

4. The method of claim 1, further comprising:
subsequent to generating the code executable to implement the first data replication policy, parsing, by the computer system, the code to identify syntactical errors.

5. The method of claim 4, further comprising:
in response to a determination that the code does not include syntactical errors, sending, by the computer system, the code to a source datacenter, wherein the source database is maintained at the source datacenter.

6. The method of claim 1, further comprising:
receiving, by the computer system, the transformed version of the first database object; and
sending, by the computer system, the transformed version of the first database object to a target datacenter, wherein the target database is maintained at the target datacenter.

7. The method of claim 6, further comprising:
receiving, by the computer system, second user input provided via the GUI that defines a second data replication policy, wherein the second user input indicates a second series of transformations to be performed, on one or more database objects, prior to storage in the target database at the target datacenter;
based on the second user input, generating, by the computer system, second code executable to implement the second data replication policy, wherein the second code is usable to perform the second series of transformations on the transformed version of the first database object; and
sending, by the computer system, the second code to at least one computer system at the target datacenter.

8. The method of claim 7, wherein a source datacenter, at which the source database is maintained, and the target datacenter are located in different countries.

9. The method of claim 1, wherein the source database is a multi-tenant database configured to store data for a plurality of tenants, and wherein the data replication policy is usable to replicate database objects, from the source database, that are associated with a first one of the plurality of tenants.

10. A non-transitory, computer-readable medium having instructions stored thereon that are capable of being executed by a computer system to cause operations comprising:
providing, to a client device, code usable to generate a graphical user interface (GUI) that enables a user of the client device to define a data replication policy, via the GUI, to be implemented during a data replication operation;
receiving, from the client device, user input provided via the GUI that defines a first data replication policy, wherein the user input indicates a series of transformations to be performed, as part of the first data replication policy, on a first database object from a source database to replicate a transformed version of the first database object to a target database; and
based on the user input, generating code executable to implement the first data replication policy, wherein the code is usable to perform the series of transformations on the first database object to generate the transformed version of the first database object.

11. The non-transitory, computer-readable medium of claim 10, wherein the operations further comprise:
subsequent to generating the code executable to implement the first data replication policy, validating the code to detect syntactical and semantical errors.

12. The non-transitory, computer-readable medium of claim 10, wherein the operations further comprise:
receiving, by the computer system, second user input associated with a second database object in the source database, wherein the second user input corresponds to a second series of transformations to be performed, as part of the first data replication policy, to replicate a transformed version of the second database object.

13. The non-transitory, computer-readable medium of claim 12, wherein the generating the code executable to implement the first data replication policy includes:
generating one or more code statements that are executable to perform the second series of transformations, on the second database object, in an order specified by the second user input, wherein the second database object is a different object-type than the first database object, and wherein the second series of transformations is different from the series of transformations to be performed on the first database object.

14. The non-transitory, computer-readable medium of claim 10, wherein the receiving the user input includes detecting, by the computer system, the user input performed via the GUI on the client device; and wherein the code executable to implement the first data replication policy is generated, by the computer system, without further user action by the user.

15. A method, comprising:
generating, by a server system, code indicative of a graphical user interface (GUI) that is operable to:
provide information corresponding to a plurality of database objects from a source database to a user; and
receive transformation instructions from the user specifying one or more transformations to be performed on a given one of the plurality of database objects during a data replication operation;
sending, by the server system, the code indicative of the GUI to a client device;
receiving, by the server system from the client device, a set of user-specified transformation instructions provided via the GUI, wherein the set of user-specified transformation instructions indicate a first plurality of transformations to be performed on a first database object of the plurality of database objects; and
based on the set of user-specified transformation instructions, generating, by the server system, code executable to implement a data replication policy, wherein the code includes code statements executable to perform the first plurality of transformations on the first database object.

16. The method of claim 15, wherein the set of user-specified transformation instructions further indicate:
metadata associated with the first database object; and
an order in which the first plurality of transformations are to be performed on the first database object; and
wherein the generating the code executable to implement the data replication policy includes generating one or more code statements that are executable to perform the first plurality of transformations, on the first database object, in the order indicated by the set of user-specified transformation instructions.

17. The method of claim 15, wherein the first plurality of transformations includes at least one of:
modifying a name associated with the first database object; and
modifying a value associated with the first database object.

18. The method of claim 17, wherein the modifying the value associated with the first database object includes encrypting the value using a first encryption algorithm.

19. The method of claim 18, wherein the first encryption algorithm is the Secure Hash Algorithm 1 (SHA1).

20. The method of claim 15, wherein the plurality of database objects are maintained in a first database at a first datacenter, wherein the method further comprises:
sending, by the server system, the code executable to implement the data replication policy to a computer system at the first datacenter;
subsequent to the sending, receiving, by the server system from the computer system at the first datacenter, a transformed version of the first database object; and
sending, by the server system, the transformed version of the first database object to a second computer system at a second datacenter for storage in a second database.
